(19) United States
(12) Patent Application Publication
(10) Pub. No.: US 2018/0060558 A1
(43) Pub. Date: Mar. 1, 2018

(54) METHOD OF AUTHENTICATING A USER AT A SECURITY DEVICE

(71) Applicant: Fujitsu Technology Solutions Intellectual Property GmbH, Munchen (DE)

(72) Inventors: Timo Bruderek, Munchen (DE); Thilo Cestonaro, Munchen (DE)

(21) Appl. No.: 15/681,870

(22) Filed: Aug. 21, 2017

(30) Foreign Application Priority Data
Aug. 24, 2016 (DE) 10 2016 115 715.5

(51) Int. Cl. G06F 21/34; H04L 9/32; H04L 29/06

(52) U.S. Cl. CPC G06F 21/34; G06F 21/62; H04L 63/0853; H04L 9/3213

(57) ABSTRACT

A method of authenticating a user at a security device includes providing a first pattern on an authentication device capable of wireless data transmission; searching for authentication devices by the security device via a wireless data connection; loading the first patterns of all found authentication devices in a memory of the security device via the wireless data connection; detecting a second pattern by a detection device of the security device; comparing the detected second pattern to the loaded first patterns; and positively authenticating the user when the detected second pattern matches one of the loaded first patterns.

### TECHNICAL FIELD

This disclosure relates to a method of authenticating a user at a security device.

### BACKGROUND

Authentications may be required in various situations when a certain user group is to be provided with physical or virtual access to an object or an area. For example, authentication of a user can be effected when the user intends to log-in to a computer system. An alternative would be an authentication of a user when the user enters a building or a group of buildings.

EP 167257 A1 describes a double identification via tokens. In that case, a user provides personal data via a token, e.g. an identification number (ID number). After that, a device detects biometric identification data, which is verified together with the personal data against a database via a computer system, the database storing both personal data and biometric identification data for each authenticated user.

There is a need to provide an advantageous authentication method and a security device.

### SUMMARY

We provide a method of authenticating a user at a security device including providing a first pattern on an authentication device capable of wireless data transmission; searching for authentication devices by the security device via a wireless data connection; loading the first patterns of all found authentication devices in a memory of the security device via the wireless data connection; detecting a second pattern by a detection device of the security device; comparing the detected second pattern to the loaded first patterns; and positively authenticating the user when the detected second pattern matches one of the loaded first patterns.

### BRIEF DESCRIPTION OF THE DRAWINGS

FIG. 1 shows an arrangement with a security device according to one configuration in a schematic block diagram.

FIG. 2 is a flow chart for a method according to one configuration.

### LIST OF REFERENCE CHARACTERS

10 Security device
11 Detection device
12 Server
13, 14, 15, 16 Authentication device
200 Flow diagram
201 to 214 Method steps

### DETAILED DESCRIPTION

We provide a method of authenticating a user at a security device. The method comprises the steps of:
providing a first pattern on an authentication device capable of wireless transmission;
searching for authentication devices by the security device via a wireless data connection;
loading all first patterns of all found authentication devices in a memory of the security device via the wireless data connection;
detecting a second pattern by a detection device of the security device;
comparing the detected second pattern with the loaded first pattern; and
positively authenticating the user when the detected second pattern matches one of the loaded first patterns.

A first pattern is provided on an authentication device. The authentication device is capable of wireless data transmission. The first pattern is a pattern that can be used for the identification of a user. For example, the authentication device is a token that can be addressed through a wireless connection. For example, the security device searches for authentication devices via a wireless data connection. In this case, all authentication devices within reach of the wireless data connection are detected. After that, the first patterns are automatically read from each authentication device found and loaded in a memory of the security device. Via a detection device, the security device detects a second pattern that can be verified against the loaded first pattern. If the second pattern matches one of the loaded first patterns, the user is positively authenticated and obtains physical or virtual access to the object protected by the security device. Access to a building or access to a computer system can be protected in this way, for example. As a first action, the user of the authentication device can perform the presentation of the second pattern before the detection device. A prior manual presentation of the authentication device is omitted. The token and the first pattern provide two factors for an authentication (two-factor authentication).

The first and the second pattern may include biometric data. Biometric data facilitate an authentication for the user since the biometric data is always available. For example, the detection device is a palm vein scanner that can detect a palm vein pattern accordingly. Other scanners that detect further or other biometric data are also possible.

Providing the first pattern at the authentication device may include an encrypting and signing of the first pattern. In this case, the loading step includes a signature verification and a decryption of each first pattern. The protection of a pattern by a signature and a key increases security of the authentication method toward unauthorized access attempts. For example, the first pattern is encrypted with a public key of the device issuing the first pattern. The signature may be a signature of the manufacturer, respectively a signature provided by the issuing device.

The step of positively authenticating the user may comprise a verification of personal data. In this case, in addition to the match between the detected second pattern and the loaded first pattern, a permission on the basis of the personal data must be present for a positive authentication of the user.

As a result, security of the authentication check is further increased. Verification of the personal data can be effected via a server, e.g. a backend server. To that end, the personal data can be sent to the server by the security device, be verified by the server, and the result of the verification can be returned.

After the verification step, after identification of a matching loaded first pattern to the detected second pattern, in addition, a further verification between the matching first pattern and the detected second pattern may be performed. In this case, a positive result of the further verification represents a further requirement for the positive authentication of the user in the step of the positive authentication.

A detection of a first pattern that matches the second pattern per se provides a high level of security of the matching of the two patterns. This can be referred to as identification. To further increase the security of the verification, a second verification can be performed subsequently according to the above explanations, which verifies the detected second pattern and the identified first pattern once again, thereby verifying the identification. For example, an identification is safe up to a maximum amount of 1000 patterns. A verification allows increasing the security up to a probability of 1:8,000,000.

After the verification step, the detected second pattern may be deleted from the memory of the security device.

The loaded first pattern may be deleted from the memory of the security device when the authentication device associated with the loaded first pattern is no longer detected by the security device, e.g. because it is turned off or out of reach of a radio connection.

Deletion of the two patterns from the memory of the security device ensures a high level of security in the management of the user data and the patterns. In this way, used patterns are prevented from being accessed and misused at a later point of time.

The wireless network connection may be a Bluetooth Low Energy connection. Low power is transmitted by the use of Bluetooth Low Energy. Thus, primary or secondary batteries of the authentication device have a longer service life.

Our methods will hereinafter be explained in greater detail by examples and the figures.

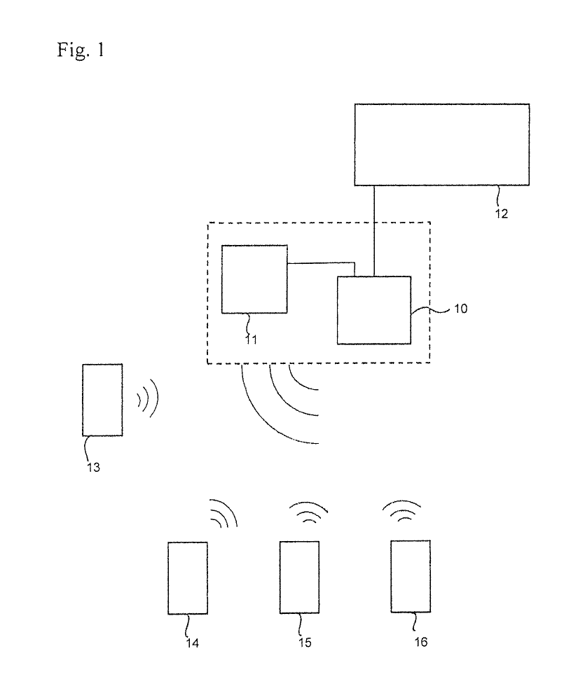

FIG. 1 shows an arrangement with a security device 10 in a schematic block diagram. The security device 10 connects to a detection device 11. In the example, the detection device 11 is a palm vein scanner. In this case, the security device 10, in particular the electronics of the security device 10, and the detection device 11 are arranged in one housing (shown by dashed lines in FIG. 1). In another example, the detection device 11 can also be an external device electronically connected to the security device 10.

The security device 10 connects to a server 12. In the example shown, the security device 10 connects to a server 12 via the internet. The server 12 can be remote in a facility of a manufacturer. In another example, the security device 10 connects to the server 12 via a cable, e.g. a LAN cable. In further examples, the security device 10 can just as well connect to the server 12 via a wireless network connection, e.g. a Wireless Local Area Network (WLAN).

FIG. 1 further illustrates an authentication device 13. In addition, further authentication devices 14, 15 and 16 are illustrated. In the illustrated example, the authentication devices 13 to 16 are identical in construction. However, authentication devices of different design are also possible. In the example, the authentication devices 13 to 16 are special devices, so-called tokens. Alternatively, one or multiple of the authentication devices 13 to 16 may have a different configuration, for example, one or multiple of the authentication devices 13 to 16 can be a mobile phone or a smartphone providing the functionality.

Each of the authentication devices 13 to 16 is equipped with a wireless data connection technology, BTLE (Bluetooth Low Energy) in the example. In other examples, other wireless data connection technologies can be used such as Bluetooth or WLAN. A maximum range of the data connection technology used is great enough so that the authentication devices 13 to 16 can be detected without the user having to manually present them. In other words, the range is greater than a typical near field communication (NFC) range (a typical NFC range is considered to be a distance of up to approximately 0,1 m). The authentication devices 13 to 16 are configured to communicate with the security device 10 via the wireless data connection technology. To that end, the security device 10 can provide a wireless data connection to which the authentication devices 13 to 16 can connect. This may be effected automatically in that the security device 10 automatically tries to contact each device within the range of the wireless data connection and, upon successful contacting, a data connection is mutually established. Alternatively, the authentication devices 13 to 16 are configured to search for a security device 10 and, upon detection of a security device 10, to automatically connect to it.

The arrangement according to FIG. 1 can be used to authenticate a user of one of the authentication devices 13 to 16. The user can be registered in the server 12. To that end, first patterns are stored in the authentication devices 13 to 16. Each pattern includes personal data, in particular biometric data, of a user.

Hereinafter, authentication of a user who possesses the authentication device 13 is exemplified. Of course, other users having other authentication devices, e.g. authentication devices 14, 15 and 16, can authenticate themselves accordingly.

The authentication device 13 connects to a generation station (not illustrated in FIG. 1) to store the first pattern on the authentication device 13. The generation device generates a first pattern.

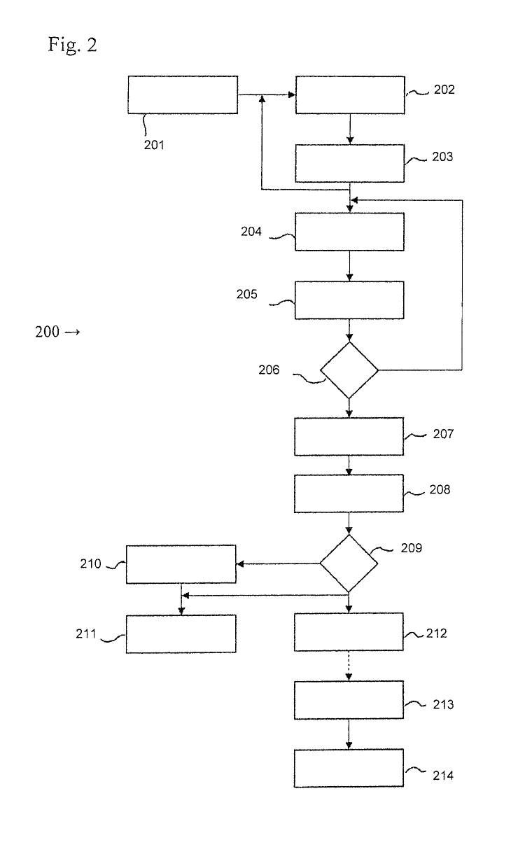

The generation station can just as well be a security device such as the security device 10. However, it is also possible that the generation station is a security device not structurally identical to the security device 10. By reading out a detection device, the generation station generates a first pattern assigned to the user of the authentication device 13. The generation station encrypts the first pattern of the user, stores the encrypted first pattern in a file and signs the file. As an alternative or in addition, the file can per se be encrypted. The file with the encrypted and signed first pattern is stored on the authentication device 13 in a password-protected manner. In this case, the file is a BLOB (Binary Large Object). In the described example, the BLOB includes both the first pattern and personal data such as a name or a personnel number. In another example, the personal data can also be stored in a separate file on the authentication device 13. To process the BLOB in the security device 10, the security device 10 reads the BLOB from of the authentication device 13, checks the signature and decrypts the file. The first pattern is available to the security device 10 then. Hereinafter, the authentication method is explained in detail with reference to FIG. 2.

FIG. 2 shows a flow diagram 200. In step 201, as described above, the first pattern is stored as a BLOB on the authentication device 13 and thus provided for use.

In step 202, the security device 10 searches for authentication devices. In doing so, the security device 10 finds all authentication devices 13 to 16 located within the range of the wireless data connection (see FIG. 1). Since BTLE is used, which has a shorter range than a conventional Bluetooth connection, the security device 10 thus detects all authentication devices within a radius of up to 10 m (depending on the signal strength, the maximum range of the BTLE connection in other examples can also vary and be between 5 and 15 m). The short range of the wireless data connection protects the authentication system in a manner as illustrated in the arrangement of FIG. 1. If the range of the wireless data connection was greater, potential attackers would have more options to access the security device 10 via the wireless data connection since they could start an attack from a greater distance. Another advantage of BTLE is that little energy is consumed in sending data due to the short range. Thus, batteries in the authentication devices 13 to 16 have a longer service life. The security device 10 finds the authentication devices 13 to 16 by searching the authentication devices 13 to 16 in step 202.

In step 203, the security device 10 downloads the first patterns from all found authentication devices 13 to 16 via the wireless data connection. In the example, a check is done to determine whether the first pattern had already been uploaded. However, it is also possible that all patterns are always loaded along with each search cycle. In doing so, identical patterns can be overwritten. The detected first patterns are stored in the security device 10 in a memory, in particular a non-volatile memory. The use of a non-volatile memory is advantageous since the detected first patterns are automatically deleted and get lost in a power outage. Thus, it is ensured that the detected first patterns are only temporarily stored in the security device 10.

Steps 202 and 203 are repeatedly performed by the security device 10 so that all authentication devices 13 to 16 within reach of the wireless data connection are continuously detected.

In step 204, the security device 10 detects a second pattern via the detection device 11. In the described example, the detection device 11 is a palm vein scanner and thus detects a palm vein pattern of the user of the authentication device 13.

For detection of the second pattern by the detection device, the security device 10 can perform a detection by the detection device 11 at predetermined time intervals. If no palm vein pattern is detected, no measures are taken. If a palm vein pattern is detected, this pattern is also loaded in a memory of the security device 10, i.e., in a memory of the security device 10 assigned to the detection device 11. In a further configuration, the same memory is used to that end as the one used by the security device 10 for storing the first pattern.

The method steps 202 to 204 are fully-automatically performed by the security device 10. The user of the authentication device 13 can perform, as a first action, the presentation of the palm in front of the detection device 11. A prior manual presentation of the authentication device 13 is omitted. The connection between the security device 10 and the authentication device 13 as well as the loading of the first pattern from the authentication device 13 is effected without any interaction on behalf of the user due to the wireless data connection so that the user does not explicitly have to present the authentication device 13 to the security device 10. In particular, the user of the authentication device 13 does not have to place the authentication device on a scanner, sensor or card reader in or at the security device 10. In this way, a two-component authentication is possible without the authentication device 13 requiring separate additional user interaction.

In step 205, the detected second pattern is compared to each first pattern loaded in the memory of the security device 10. In doing so, the loaded first patterns are processed in accordance with a predetermined order, e.g. by a list.

In step 206, a decision is made as to whether a comparison of step 205 was successful or not. If no match was found, the method is repeated and a second pattern is again via the detection device 11. The method is repeated as from step 204 then. As an alternative, an error message can be output and the method can be stopped. However, if a match is found, the comparing started in step 205 is stopped and the method continues at step 207. As an alternative, the method continues at step 208, if the optional step 207 (see below) is omitted. In a further alternative configuration, the comparing is not stopped even if a match was found, but rather all loaded first patterns are verified. In this case, after that, if exactly one match was found, the found first pattern is authenticated, i.e., evaluated to be successfully verified. In other cases (no match or multiple matches), the comparing is evaluated as having failed.

Step 207 represents an optional verification of the verification between the found first pattern and the detected second pattern. In the verification, the detected second pattern is once again checked against the loaded first pattern from the memory of the security device 10. In this case, verification can be more detailed than in the first authentication (the identification) in the step 205. If it is determined, in the verification, that the identification was incorrect, i.e., that the found first pattern does not match the detected second pattern after all, the method is stopped and repeated in step 204, if applicable. However, this is not shown in the flow chart 200 for the sake of clarity. In an example, which is not shown, step 207, i.e., the verification, is completely omitted. Data security would be lower in favor of a faster process flow.

Hereinafter, it is assumed that the verification in step 207 was performed and was successful, or no verification was performed and the verification in step 206 was evaluated to be valid.

In step 208, personal data of the user stored in the BLOB in the authentication device 13 in addition to the first pattern, is verified against data located on the server 12. The personal data can be a user name, an age and/or a personnel number. This personal data is thus verified against personal data stored in a database on the server 12, e.g. a personnel database, in addition to the verification of the patterns for the sake of security. For example, the personal data is sent to the server 12 via the security device 10, the server performing the verification of the personal data and sending a result of the verification to the security device 10.

In step 209, a decision is made as to whether verification of the personal data was successful. If the verification was not successful, the user of the authentication device 13 is denied physical or virtual access in step 210. Thus, authentication is evaluated to be negative and the method is completed for the user. After that, in step 211, the detected second patterns in the security device 10 are deleted. In other words, both the stored second pattern detected by the detection device 11 is deleted from the remaining memory of the security device 10.

If the authentication was successful, i.e., in the case that even the verification of the personal data via the server 12 was evaluated to be successful in addition to the verification of the first pattern against the second pattern, authentication is granted to the user in step 212, i.e., the authentication is positively completed. In addition, step 211 is performed at the same time as the positive authentication, just like in the negative authentication. In other words, even if the user of the authentication device 13 has positively authenticated him or herself, the second pattern associated with the authentication device 13 and the user thereof is deleted from the security device 10.

At this time or later, the user and his or her authentication device 13 will leave the detection range of the security device 10. Once the security device 10 does not detect the authentication device 13 in step 213, the stored first pattern is deleted from the memory of the security device 190 in step 214. At this point, there are no personal data about the user left in the security device 10. The method was completed.

In the flow diagram 200 and the associated description, repetitions of certain steps or step sequences, e.g. steps 202 and 203, were described. The repetitions are to be understood as being exemplary. Of course, it is also possible that a repetition of the searching of the authentication device is effected at a shorter or longer time independently from the method steps of the authentication method, e.g. each second.

The verification of the personal data in steps 208 and 209 as well as the verification of the first pattern against the second pattern in steps 205 to 207 can be performed in reverse order in an alternative configuration, i.e., steps 208 and 209 are performed first, and then steps 205 and 206 (and optionally 207). In another alternative example, the verification of the personal data can be effected independently from the progress of the verification of the first and second patterns. Incidentally, a verification of the personal data may have been effected already before the user of the authentication device 13 approaches the security device 10. In this case, a positive authentication result of the personal data would be stored with respect to the first pattern such that the associated second pattern can be detected and verified accordingly. A verification of the personal data after the verification of the patterns is omitted.

1. A method of authenticating a user at a security device comprising:
providing a first pattern on an authentication device capable of wireless data transmission;
searching for authentication devices by the security device via a wireless data connection;
loading the first patterns of all found authentication devices in a memory of the security device via the wireless data connection;
detecting a second pattern by a detection device of the security device;
comparing the detected second pattern to the loaded first patterns; and
positively authenticating the user when the detected second pattern matches one of the loaded first patterns.

2. The method according to claim 1, wherein the first pattern and the detected second pattern comprise biometric data.

3. The method according to claim 1, wherein provision of the first pattern on the authentication device includes an encrypting and signing of the first pattern, and loading includes a signature verification and a decryption of each first pattern.

4. The method according to claim 1, wherein the positive authentication of the user includes a verification of personal data, and, in addition to the match between the detected second pattern and the loaded first pattern, a permission on the basis of the personal data must be present to positively authenticate the user.

5. The method according to claim 1, wherein after the verification, after an identification of a matching of the loaded first pattern with the detected second pattern, additionally a further verification between the matching first pattern and the detected second pattern is performed, and a positive result of the further verification represents a further requirement for the positive authentication of the user.

6. The method according to claim 1, wherein after the verification, the detected second pattern is deleted from the memory of the security device.

7. The method according to claim 1, wherein the loaded first pattern is deleted from the memory of the security device when the authentication device associated with the loaded first pattern is no longer detected by the security device.

8. The method according to claim 1, wherein the wireless data network connection is a Bluetooth Low Energy connection.

9. The method according to claim 2, wherein provision of the first pattern on the authentication device includes an encrypting and signing of the first pattern, and loading includes a signature verification and a decryption of each first pattern.

10. The method according to claim 2, wherein the positive authentication of the user includes a verification of personal data, and, in addition to the match between the detected second pattern and the loaded first pattern, a permission on the basis of the personal data must be present to positively authenticate the user.

11. The method according to claim 3, wherein the positive authentication of the user includes a verification of personal data, and, in addition to the match between the detected second pattern and the loaded first pattern, a permission on the basis of the personal data must be present to positively authenticate the user.

12. The method according to claim 2, wherein after the verification, after an identification of a matching of the loaded first pattern with the detected second pattern, additionally a further verification between the matching first pattern and the detected second pattern is performed, and a positive result of the further verification represents a further requirement for the positive authentication of the user.

13. The method according to claim 3, wherein after the verification, after an identification of a matching of the loaded first pattern with the detected second pattern, additionally a further verification between the matching first pattern and the detected second pattern is performed, and a positive result of the further verification represents a further requirement for the positive authentication of the user.

14. The method according to claim 4, wherein after the verification, after an identification of a matching of the loaded first pattern with the detected second pattern, additionally a further verification between the matching first pattern and the detected second pattern is performed, and a positive result of the further verification represents a further requirement for the positive authentication of the user.

15. The method according to claim 2, wherein after the verification, the detected second pattern is deleted from the memory of the security device.

16. The method according to claim 3, wherein after the verification, the detected second pattern is deleted from the memory of the security device.

17. The method according to claim 4, wherein after the verification, the detected second pattern is deleted from the memory of the security device.

18. The method according to claim 5, wherein after the verification, the detected second pattern is deleted from the memory of the security device.

19. The method according to claim 2, wherein the loaded first pattern is deleted from the memory of the security device when the authentication device associated with the loaded first pattern is no longer detected by the security device.

20. The method according to claim 3, wherein the loaded first pattern is deleted from the memory of the security device when the authentication device associated with the loaded first pattern is no longer detected by the security device.
